(19) United States
(12) Patent Application Publication
(10) Pub. No.: US 2022/0368206 A1
(43) Pub. Date: Nov. 17, 2022

(54) LINEAR VIBRATION MOTOR

(71) Applicant: AAC Microtech (Changzhou) Co., Ltd., Changzhou City (CN)

(72) Inventors: Jie Ma, Shenzhen (CN); Kejia Liu, Shenzhen (CN); Lubin Mao, Shenzhen (CN); Zhiyong Cui, Shenzhen (CN)

(21) Appl. No.: 17/541,294

(22) Filed: Dec. 3, 2021

(30) Foreign Application Priority Data
May 11, 2021 (CN) 202121001582.7

(51) Int. Cl. H02K 33/02

(52) U.S. Cl. CPC H02K 33/02; B06B 1/045

(57) ABSTRACT

One of the objects of the present invention is to provide a linear vibration motor which improves damping performance and reduces assembly costs. Accordingly, the present invention provides a linear vibration motor having a box body with an inner cavity; a weight accommodated in the box body; a stator in the box body; an elastic member suspending the weight in the box body, including a first elastic member and a second elastic member fixedly connected to opposite sides of the weight; and a first damping glue locating between and abutting against the first elastic member and the weight. The first elastic member includes a first fixed part fixedly connected to the weight and a first elastic bracket extending from the first fixed part; the first damping glue locates at one end of the first elastic bracket close to the first fixed part.

### FIELD OF THE PRESENT DISCLOSURE

The present disclosure relates to motors, in particular to a linear vibration motor for providing tactile feedback.

### DESCRIPTION OF RELATED ART

Portable electronic devices such as mobile phones, handheld game consoles, and navigation devices in the prior art are becoming more and more popular. These products generally use linear vibration motors for system feedback, such as mobile phone call prompts, information prompts, navigation prompts, and vibration feedback from game consoles.

A related linear vibration motor usually includes a housing with an accommodation space, a stator accommodated in the housing, a vibrator, and a V-shaped spring. The stator includes a voice coil (coil), an iron core, a magnetic conductive sheet and FPC (Flexible Printed Circuit). The vibrator includes a magnet and a weight. The vibrator and the stator are connected by a V-shaped spring. The magnet is arranged in the middle of the upper and lower stator.

As for the related linear vibration motor, foam is provided on the side of the V-shaped spring close to the weight and the side of the weight facing the V-shaped spring. And the foam is located in the middle of the weight side to increase the damping value of the linear vibration motor by setting the above foam. Adding foam to the linear vibration motor, however, will cause the V-new spring to deform greatly after the foam is compressed. As a result, the damping value provided by the foam located in the middle of the weight side is smaller. Cannot meet the performance requirements of linear vibration motors.

### SUMMARY OF THE PRESENT INVENTION

One of the objects of the present invention is to provide a linear vibration motor which improves damping performance and reduces assembly costs.

To achieve the above-mentioned objects, the present invention provides a linear vibration motor having a box body with an inner cavity; a weight accommodated in the box body; a stator in the box body; an elastic member suspending the weight in the box body, including a first elastic member and a second elastic member fixedly connected to opposite sides of the weight; and a first damping glue locating between and abutting against the first elastic member and the weight. The first elastic member includes a first fixed part fixedly connected to the weight and a first elastic bracket extending from the first fixed part; the first damping glue locates at one end of the first elastic bracket close to the first fixed part.

In addition, the first elastic member further includes a second fixed part opposite to the first fixed part and fixedly connected to an inner wall of the box body, and a second elastic brake extending from the second fixed part and connecting with the first elastic brake for forming a V shape.

In addition, a side of the weight facing the first elastic member forms a first accommodation cavity for accommodating the first damping glue; the first damping glue is embedded in the first accommodation cavity and protrudes out of the first accommodation cavity.

In addition, the linear vibration motor further comprises a second damping glue connected between the second elastic member and the weight, wherein the second elastic member locates on a side of the weight away from the first elastic member; the second elastic member includes a third fixed part fixedly connected to the weight and a third elastic bracket extending from the third fixed part; the second damping glue is arranged at one end of the third elastic bracket close to the third fixed part.

In addition, the second elastic member further includes a fourth fixed part fixedly connected to an inner wall of the box body, and a fourth elastic bracket extending from the fourth fixed part and bendingly connected to the third elastic bracket for forming a V shape; the third fixed part is arranged opposite to the fourth fixed part.

In addition, a side of the weight facing the second elastic member forms a second accommodation cavity for accommodating the second damping glue which protrudes out of the second accommodation cavity.

In addition, one end of the first accommodation cavity penetrates the bottom of the weight, and the other end extends toward the top of the weight to a set distance; a first sealant is received in the first accommodation cavity on a side close to the bottom of the weight; the first damping glue is located on a side of the first sealant away from the bottom of the weight.

In addition, the linear vibration motor further comprises a second sealant in the first accommodation cavity; wherein the first damping glue locates between the first sealant and the second sealant.

In Addition, wherein one end of the second accommodation cavity penetrates the bottom of the weight, and the other end extends toward the top of the weight for forming a distance; a third sealant is provided in the second accommodation cavity on a side close to the bottom of the weight; the second damping glue is located on a side of the third sealant away from the bottom of the weight.

In addition, the linear vibration motor further comprises a fourth sealant in the second accommodation cavity; and the second damping glue locates between the third sealant and the fourth sealant.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 is an exploded and isometric view of a linear vibration motor in accordance with an exemplary embodiment of the present invention.

FIG. 2 is a cross-sectional view of the linear vibration motor taken along line AA in FIG. 1.

FIG. 3 is a first exploded view of a stator, a vibrator and an elastic member of the linear vibration motor in FIG. 1.

FIG. 4 is similar to FIG. 3 illustrating a second exploded view of the stator, the vibrator and the elastic member of the linear vibration motor.

FIG. 5 is a top view of a box body, the stator, the vibrator and the elastic member of the linear vibration motor.

### DETAILED DESCRIPTION OF THE EXEMPLARY EMBODIMENTS

The present disclosure will hereinafter be described in detail with reference to exemplary embodiments. To make the technical problems to be solved, technical solutions and beneficial effects of the present disclosure more apparent, the present disclosure is described in further detail together with the figures and the embodiments. It should be understood the specific embodiments described hereby are only to explain the disclosure, not intended to limit the disclosure.

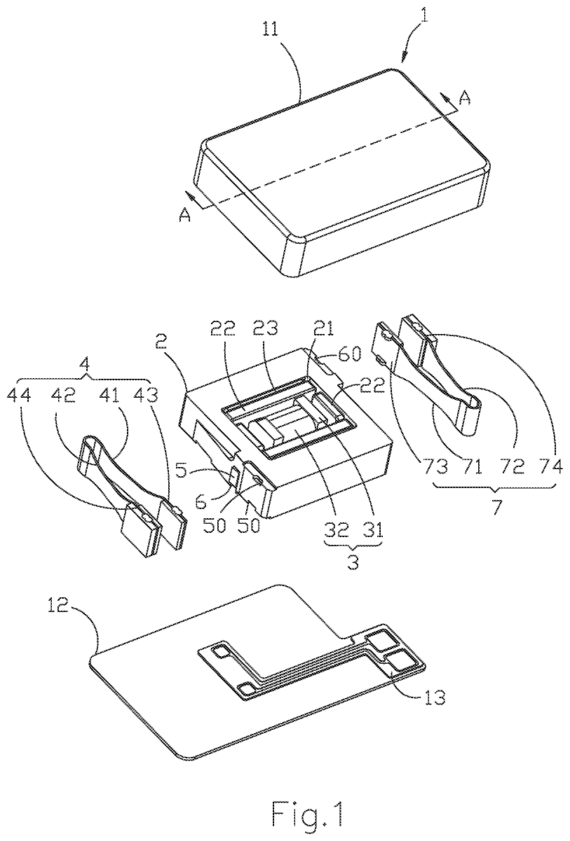

As shown in FIG. 1 and FIG. 5, a linear vibration motor includes a box body 1, a weight accommodated in the box body 1, a stator 3 located in the weight 2, and an elastic member that suspends the weight 2 in the box body 1. The elastic member includes a first elastic member 4. The first elastic member 4 is located on the side of weight 2. One end of the first elastic member 4 is connected to the end of the side wall of the weight 2, and the other end is connected to the side wall of the box body 1. Wherein, the first elastic member 4 includes a first fixed part 43 fixedly connected to the weight 2 and a first elastic bracket 41 extending from the first fixed part 43, a second fixed part 44 connected to the inner wall of the box body 1 and a second elastic bracket 42 extending from the second fixed part 44 and bent and connected with the first elastic bracket 41 to form a V-shape. The first fixed part 43 is fixedly connected to the weight 2 and the second fixed part 44 is fixedly connected to the inner wall of the box body 1. In this way, weight 2 can better reciprocate within the box body 1 under the elastic abutment of the first elastic member 4.

A first damping glue 5 abuts between the side walls of the first elastic member 4 and the weight 2 in the direction close to one end of the first fixed part 43. By virtue of the first damping glue 5, when the weight 2 is displaced in the box body 1, the first damping glue 5 causes the first elastic member 4 and the weight 2 to produce greater mechanical damping. Wherein, the rigidity of the first damping glue 5 is weaker than that of the foam compared with the foam used in the prior art. Therefore, it is difficult to cause excessive deformation of the elastic member after the foam is compressed. As a result, the damping value provided by the foam becomes smaller, thereby reducing the impact on the operating frequency of the linear vibration motor. In addition, in the assembly process of the linear vibration motor, assembling the first damping glue 5 only needs to be injected and fixed. Compared with the foam assembly process in the prior art, the assembly process using the first damping glue 5 is simpler and the assembly cost is lower.

The first damping glue 5 is arranged close to the junction of first elastic bracket 41 and the weight 2. That is, first damping glue 5 is arranged close to the first fixed part 43. The first elastic member 4 is arranged in a V shape, so that a gap with an included angle is formed between the first elastic member 4 and the side wall of the weight 2. In turn, the closer to the connection, the smaller the gap. Therefore, it is difficult for the first damping glue 5 arranged near the above-mentioned connection to leak through the above-mentioned gap.

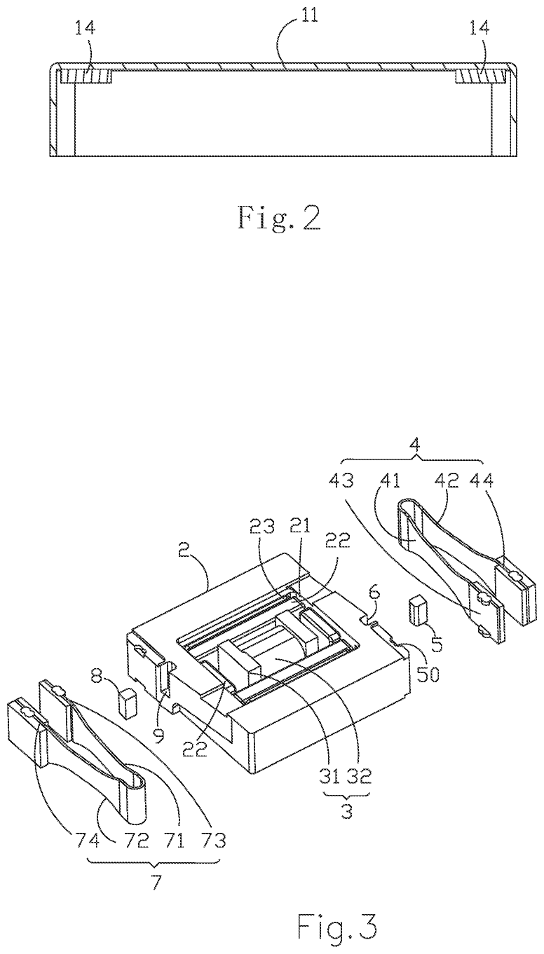

As a specific embodiment, as shown in FIG. 1, the box body 1 includes an upper box body 11 and a lower box body 12 spliced with the upper box body 11. The lower box body 12 is provided with a circuit board 13 electrically connected to the stator 3. An accommodation cavity 21 is arranged on the weight 2. The stator 3 is located in the accommodation cavity 21. 22 magnet is provided on the peripheral wall of accommodation cavity 21. A magnetic conductive sheet 23 is provided on the sidewall of the accommodation cavity 21 parallel to the axis direction of the stator 3. The magnetic conductive sheet 23 is located between the magnet 22 and the side wall of the accommodation cavity 21. The stator 3 includes an iron core 31 fixed on the lower box body 11 and a coil 32 wound on the iron core 31. The iron core 31 equipped with the coil 32 is located in the accommodation cavity 21. And magnet 22 is located in its circumferential direction. Wherein, as shown in FIG. 2, two position limiting sheets 14 are provided on the side wall of the upper box body 11 facing the lower box body 12. In this way, the position of weight 2 reciprocating within the box body 1 is effectively restricted. Reduce weight 2 excessively squeeze the elastic member and cause the elastic member to undergo elastic deformation too quickly, thereby increasing the service life of the elastic member.

As shown in FIGS. 1-3, the side of the weight 2 facing the first elastic member 4 is recessed with a first accommodation cavity 6 for accommodating the first damping glue 5. The first accommodation cavity 6 is arranged to accommodate the first damping glue 5 in the weight 2 to increase the volume of the first damping glue 5. In this way, the first damping glue 5 abutting between the first elastic member 4 and the weight 2 is difficult to detach from the weight 2 in the first accommodation cavity 6. It effectively reduces the occurrence of the first damping glue 5 falling off the weight 2 due to the linear vibration motor falling, shaking or falling.

Wherein, the first accommodation cavity 6 is arranged close to the first fixed part 43. Set the first accommodation cavity 6 close to the first fixed part 43 to increase the volume of the first damping glue 5. In this way, the first damping glue 5 can not only be set close to the gap between the first elastic brake 41 and the weight 2, but also, the position of the first damping glue 5 is restricted by the space formed by the first accommodation cavity 6 and the first elastic member 4. In this way, it is difficult for the first damping glue 5 to be separated from the weight 2 from the first accommodation cavity 6.

The first damping glue 5 is embedded in the first accommodation cavity 6. And one end of the first damping glue 5 protruding from the accommodation cavity abuts with the first elastic member 4. Insert the first damping glue 5 into the first accommodation cavity 6 and install it. In this way, the first damping glue 5 can achieve a self-fixing effect in the first accommodation cavity 6, and the part protruding from the side wall of the weight 2 abuts the first elastic member 4 through the first damping glue 5. Not only does it make it difficult for the first damping glue 5 to break away from the first accommodation cavity 6 and weight 2. It can effectively ensure the damping performance of the first damping glue 5, thereby reducing the impact on the operating frequency of the linear vibration motor.

As shown in FIG. 1, FIG. 3 and FIG. 5, the elastic member further includes a second elastic member 7. Wherein, the second elastic member 7 includes a third fixed part 73 which is fixedly connected with the weight 2 and a third elastic bracket 71 which is extended from the third fixed part 73, a fourth fixed part 74 fixedly connected to the inner wall of box body 1, a fourth elastic bracket 72 that extends from the fourth fixed part 74 and bends and connects with the third elastic bracket 71 to form a V-shape. The third fixed part 73 and the fourth fixed part 74 are set opposite to each other. The third fixed part 73 is fixedly connected to weight 2 and the fourth fixed part 74 is fixedly connected to the inner wall of the box body 1. In this way, weight 2 can better reciprocate in the box body 1 under the elastic abutment of the second elastic member 4.

The second elastic member 7 is located on the side of weight 2 away from the first elastic member 4. And one end of the second elastic member 7 is connected to the end of the side wall of the weight 2. The other end is connected with the side wall of the box body 1 away from the first elastic member 4. Set second elastic member 7 on the side of weight 2 away from first elastic member 4. In order to achieve the purpose of suspending weight 2 in box body 1, the friction of weight 2 in box body 1 is reduced.

A second damping glue 8 abuts between the side wall of the second elastic member 7 and the side wall of the weight 2 in the direction close to the end of the third fixed part 73. A second damping glue 8 is arranged so that when the weight 2 is displaced between the first elastic member 4 and the second elastic member 7, the second damping glue 8 will cause greater mechanical damping between the second elastic member 7 and the weight 2. Wherein, the second damping glue 8 is less rigid than the foam used in the prior art in terms of rigidity. Therefore, it is difficult to cause excessive deformation of the elastic member after the foam is compressed. As a result, the damping value provided by the foam becomes smaller, thereby reducing the impact on the operating frequency of the linear vibration motor. In addition, in the assembly process of the linear vibration motor, assembling the second damping glue 8 only needs to be injected and fixed. Compared with the foam assembly process in the prior art, the assembly process using the second damping glue 8 is simpler and the assembly cost is lower.

The second damping glue 8 is arranged close to the connection between the third elastic bracket 71 of the second elastic member 7 and the weight 2. That is, the second damping glue 8 is arranged close to the third fixed part 73. Because the second elastic member 7 is arranged in a V shape, a gap with an included angle is formed between the second elastic member 7 and the side wall of the weight 2. In turn, the closer to the connection, the smaller the gap. In this way, the second damping glue 8 located near the above-mentioned connection is difficult to leak through the above-mentioned gap.

As shown in FIGS. 1 and 3, the side of the weight 2 facing the second elastic member 7 is recessed with a second accommodation cavity 9 for accommodating the second damping glue 8. And the second accommodation cavity 9 is arranged close to the junction of the second elastic member 7 and weight 2. The second accommodation cavity 9 is arranged to accommodate the second damping glue 8 in the weight 2 to increase the volume of the second damping glue 8. In this way, the second damping glue 8 abutting between the second elastic member 7 and the weight 2 is difficult to detach from the weight 2 in the second accommodation cavity 9. This effectively reduces the occurrence of the second damping glue 8 falling off from the weight 2 due to falling, shaking or falling of the linear vibration motor.

As a specific embodiment, as shown in FIGS. 1 and 3, one end of the first elastic member 4 is welded and fixed to one side of the weight 2. One end of the second elastic member 7 is welded and fixed to the side of the weight 2 away from the first elastic member 4. In this way, the first elastic member 4 and the second elastic member 7 are arranged on both sides of the weight 2. Wherein, the first elastic member 4 is arranged with an opening due to its V-shaped design. In the same way, the second elastic member 7 also has openings. Wherein, the opening of the first elastic member 4 on the weight 2 is arranged opposite to the opening of the second elastic member 7. In this way, when weight 2 moves, its stability is better than that of the one set in the same direction.

As shown in FIG. 1 and FIG. 3, the first damping glue 5 and the second damping glue 8 are set in a staggered manner. The first damping glue 5 and the second damping glue 8 are set in a staggered manner to provide the moving weight 2 with a higher damping value than the foam in the prior art. Moreover, the rigidity of the first damping glue 5 and the second damping glue 8 is relatively weak, so the relatively large mechanical damping provided by the first damping glue 5 and the second damping glue 8 hardly affects the working frequency of the motor.

As shown in FIG. 1 and FIG. 3, one end of the first accommodation cavity 6 penetrates the bottom of the weight 2. The other end extends toward the inside of the top of weight 2 to a set distance. On the one hand, it is convenient to manufacture the above-mentioned first accommodation cavity 6 on weight 2. The processing technology of the first accommodation cavity 6 is simplified, and the manufacturing cost thereof is reduced. On the other hand, it is convenient to inject the first damping glue 5 set in the first accommodation cavity 6. This simplifies the assembly process of the first damping glue 5, is easy to assemble and reduces its assembly cost.

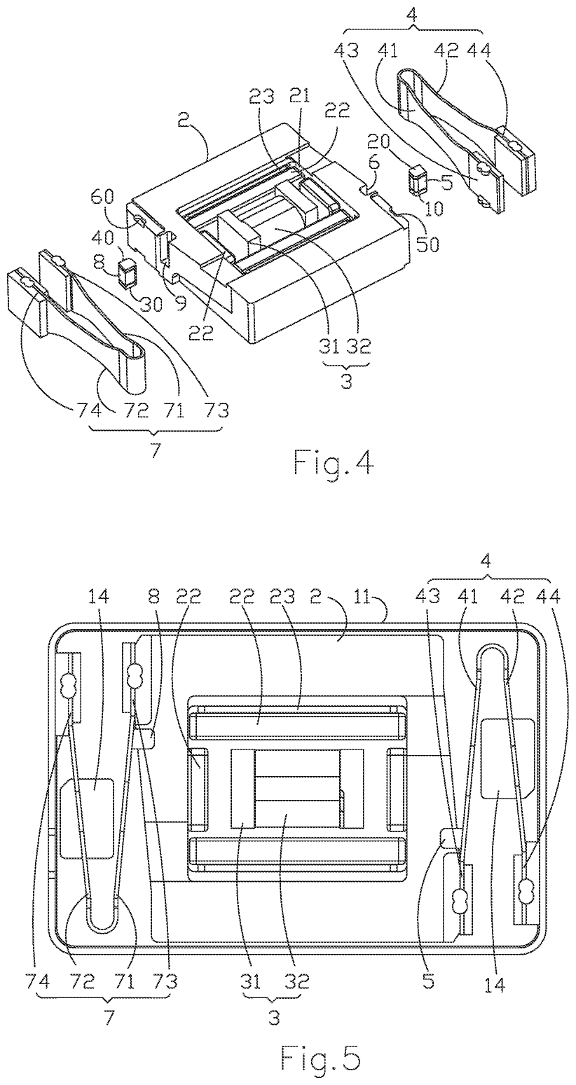

As shown in FIG. 4, the first accommodation cavity 6 is provided with a first sealant 10 on the side close to the top of the weight 2. The first damping glue 5 is located on the side of the first sealant 10 away from the top of the weight 2. A first sealant 10 is arranged at one end of the first accommodation cavity 6 close to the bottom wall of the box body 1 to reduce the leakage of the first damping glue 5 when injected into the first accommodation cavity 6.

Specifically, the viscosity of the first sealant 10 is higher than that of the first damping glue 5, so as to effectively restrict the injection into the first damping glue 5 in the first accommodation cavity 6. To minimize the leakage of the first damping glue 5 when injected into the first accommodation cavity 6.

As shown in FIG. 4, a second sealant 20 is also provided in the first accommodation cavity 6, and the first damping glue 5 is located between the first sealant 10 and the second sealant 20. The second sealant 20 is arranged at one end of the first accommodation cavity 6 close to the bottom wall of the box body 1, and the viscosity of the second sealant 20 is higher than that of the first damping glue 5. This effectively reduces the occurrence of the first damping glue 5 flowing out from the lower surface of the weight 2 through the first accommodation cavity 6 due to the linear vibration motor falling, shaking or falling.

As shown in FIGS. 3-4, one end of the second accommodation cavity 9 penetrates the bottom of weight 2, and the other end extends toward the top of weight 2 to a set distance. On the one hand, it is convenient to manufacture the second accommodation cavity 9 on the weight 2. The processing technology of the second accommodation cavity 9 is simplified, and its manufacturing cost is reduced. On the other hand, it is convenient to inject the second damping glue 8 in the second accommodation cavity 9. This simplifies the assembly process of second damping glue 8, which is easy to assemble and reduces its assembly cost.

A third sealant 30 is provided in the second accommodation cavity 9 on the side close to the top of the weight 2. The second damping glue 8 is located on the side of the third sealant 300 away from the top of the weight 2. The third sealant 30 is arranged at the end of the second accommodation cavity 9 close to the bottom wall of the box body 1 to reduce the leakage of the second damping glue 8 when injected into the second accommodation cavity 9.

Specifically, the viscosity of the second sealant 20 is higher than that of the second damping glue 8, so as to effectively limit the injection to the second damping glue 8 in the second accommodation cavity 9. To minimize the leakage of the second damping glue 8 when injected into the second accommodation cavity 9.

As shown in FIG. 4, a fourth sealant 40 is also provided in the second accommodation cavity 9. The second damping glue 8 is located between the third sealant 30 and the fourth sealant 40. Set the second sealant 20 at the end of the second accommodation cavity 9 close to the bottom wall of the box body 1. In this way, the occurrence of the second damping glue 8 flowing out from the lower surface of the weight 2 penetrated by the second accommodation cavity 9 due to the linear vibration motor being dropped, shaken or dropped is effectively reduced.

As shown in FIG. 1, FIG. 3 and FIG. 4, the distance from the central axis of the first accommodation cavity 6 to the weight 2 is the same as the distance from the central axis of the second accommodation cavity 9 to the weight 2. In this way, the weight 2 located between the first elastic member 4 and the second elastic member 7 has the same damping on both sides when moving, thereby improving the performance of the linear vibration motor.

As a specific embodiment, as shown in FIG. 1, FIG. 3, FIG. 4 and FIG. 5, the upper and lower ends of the connection part between the weight 2 and the first elastic member 4 are provided with the first welding slots 50 for accommodating welding points. The upper and lower end of the connection between the weight 2 and the second elastic member 7 are provided with second welding slots 60 for accommodating welding points.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A linear vibration motor, including:
a box body with an inner cavity;
a weight accommodated in the box body;
a stator in the box body;
an elastic member suspending the weight in the box body, including a first elastic member and a second elastic member fixedly connected to opposite sides of the weight;
a first damping glue locating between and abutting against the first elastic member and the weight; wherein
the first elastic member includes a first fixed part fixedly connected to the weight and a first elastic bracket extending from the first fixed part; the first damping glue locates at one end of the first elastic bracket close to the first fixed part.

2. The linear vibration motor as described in claim 1, wherein the first elastic member further includes a second fixed part opposite to the first fixed part and fixedly connected to an inner wall of the box body, and a second elastic brake extending from the second fixed part and connecting with the first elastic brake for forming a V shape.

3. The linear vibration motor as described in claim 1, wherein a side of the weight facing the first elastic member forms a first accommodation cavity for accommodating the first damping glue; the first damping glue is embedded in the first accommodation cavity and protrudes out of the first accommodation cavity.

4. The linear vibration motor as described in claim 2 further comprising a second damping glue connected between the second elastic member and the weight, wherein the second elastic member locates on a side of the weight away from the first elastic member; the second elastic member includes a third fixed part fixedly connected to the weight and a third elastic bracket extending from the third fixed part; the second damping glue is arranged at one end of the third elastic bracket close to the third fixed part.

5. The linear vibration motor as described in claim 4, wherein the second elastic member further includes a fourth fixed part fixedly connected to an inner wall of the box body, and a fourth elastic bracket extending from the fourth fixed part and bendingly connected to the third elastic bracket for forming a V shape; the third fixed part is arranged opposite to the fourth fixed part.

6. The linear vibration motor as described in claim 4, wherein a side of the weight facing the second elastic member forms a second accommodation cavity for accommodating the second damping glue which protrudes out of the second accommodation cavity.

7. The linear vibration motor as described in claim 3, wherein: one end of the first accommodation cavity penetrates the bottom of the weight, and the other end extends toward the top of the weight to a set distance; a first sealant is received in the first accommodation cavity on a side close to the bottom of the weight; the first damping glue is located on a side of the first sealant away from the bottom of the weight.

8. The linear vibration motor as described in claim 7 further comprising a second sealant in the first accommodation cavity; wherein the first damping glue locates between the first sealant and the second sealant.

9. The linear vibration motor as described in claim 6, wherein one end of the second accommodation cavity penetrates the bottom of the weight, and the other end extends toward the top of the weight for forming a distance; a third sealant is provided in the second accommodation cavity on a side close to the bottom of the weight; the second damping glue is located on a side of the third sealant away from the bottom of the weight.

10. The linear vibration motor as described in claim 9 further comprising a fourth sealant in the second accommodation cavity; and the second damping glue locates between the third sealant and the fourth sealant.
